(19) United States
(12) Patent Application Publication
(10) Pub. No.: US 2014/0246983 A1
(43) Pub. Date: Sep. 4, 2014

(54) LAMP

(71) Applicant: Lextar Electronics Corporation, Hsinchu (TW)

(72) Inventor: Po-Shen CHEN, Hsinchu City (TW)

(73) Assignee: Lextar Electronics Corporation, Hsinchu (TW)

(21) Appl. No.: 14/182,302

(22) Filed: Feb. 18, 2014

(30) Foreign Application Priority Data
Mar. 4, 2013 (TW) 102107519

(51) Int. Cl. H05B 33/08; H05B 37/02

(52) U.S. Cl. CPC H05B 33/0842; H05B 37/02
USPC 315/151

(57) ABSTRACT

A lamp includes a light-emitting device, a lamp cover and a lamp driver. The lamp cover covers the light-emitting device, such that the light emitted by the light-emitting device partly passes through the lamp cover and is partly reflected from the lamp cover. The lamp driver determines whether the lamp cover is damaged or the lamp cover still covers the light-emitting device based on the light reflected from the lamp cover to subsequently drive or turn off the light-emitting device selectively. The lamp driver includes a driving unit. The driving unit stops driving the light-emitting device when the lamp cover is damaged or the light-emitting device is not covered by the lamp cover. The driving unit keeps driving the light-emitting device when the lamp cover is not damaged or the light-emitting device is normally covered by the lamp cover.

### RELATED APPLICATIONS

This application claims priority to Taiwan Application Serial Number 102107519, filed Mar. 4, 2013, which is herein incorporated by reference.

### BACKGROUND

1. Field of Invention

The invention relates to a lamp, and more particularly to a lamp having a to lamp driver.

2. Description of Related Art

The incandescent light bulb and fluorescent lamp are most commonly used traditional illuminating lamps currently. However, with respect to the incandescent light bulb, most of the electric energy is converted into heat during operation, such that the luminous efficacy of the incandescent light bulb is poor, and the heat is a heavy burden to the air-conditioning. This is particularly true with respect to that the air-conditioning in subtropical zones consumes much energy to deal with the heat generated during operation of the incandescent light bulb. While the luminous efficacy of the fluorescent lamp is greater than that of the incandescent light bulb, the mercury coated on the inner wall of the fluorescent lamp includes poisonous substances such as Hg and fluorescent powder, which may result in mercury pollution and thus seriously affect the environment. Furthermore, if the incandescent light bulb and the fluorescent lamp no longer emit light under a power turn-on condition, their life may come to an end and they must be discarded. However, the space occupied by such a discarded incandescent light bulb or fluorescent lamp is large and results in a high cost for waste disposal.

A light emitting diode (LED) is a semiconductor device. Compared with the aforementioned traditional light bulb or lamp, a light bulb or lamp which uses LED(s) has more than 50-100 times the lifetime of aforementioned traditional light bulb or lamp. A lamp adopting the LED can be used for a long time without frequent lamp replacement, which reduces the number of abandoned lamps and pollution to the environment. Moreover, the LED has a higher efficiency in converting electric energy to light, lower electric power consumption (the amount of electric power consumed by the LED is approximately from one third to one fifth as much as that of the traditional lamp), and lower heat generation during operation, thereby reducing the burden on air-conditioning and the environment. Additionally, the light emitting diode is a luminous source with a small size, capable of being applied to various miniaturized devices. Therefore, by using a lamp adopting the light emitting diode, the problems of low luminous efficacy, large volume and environmental pollution of the traditional lamp are overcome. However, with respect to a lamp to adopting the LED, when the lamp cover is removed or damaged, an electric wire for providing power is exposed and this may cause a risk of electric shock to users.

In view of the above, it can be seen that the aforesaid existing lamps obviously still have disadvantages which need to be overcome. Therefore, a currently important research and development topic, indeed one that requires a prompt solution, relates to how to avoid the danger of electric shock when a lamp cover is damaged or removed.

### SUMMARY

The invention relates to a lamp to determine whether a lamp cover is damaged or the lamp cover still covers the light-emitting device by a lamp driver, such that the lamp driver subsequently drives or turns off the light-emitting device selectively. When the lamp cover is damaged or does not cover the lighting-emitting device, the lamp driver turns off the light-emitting device. Therefore, an electric wire that may be exposed as a result of such damage or removal of the lamp cover stops supplying power to thereby avoid the danger of electric shock to users.

An aspect of the invention relates to a lamp, including a light-emitting device, a lamp cover and a lamp driver. The lamp cover covers the light-emitting device, such that the light emitted by the light-emitting device partly passes through the lamp cover and is partly reflected from the lamp cover. The lamp driver determines whether the lamp cover is damaged or the lamp cover still covers the light-emitting device based on the light reflected from the lamp cover to subsequently drive or turn off the light-emitting device selectively.

The aforesaid lamp driver includes a driving unit, a power detecting unit, a light sensing unit, a comparison unit and a memory unit. The driving unit is electrically connected to an external power supply to output a drive current to the light-emitting device. The power detecting unit is connected between the driving unit and the light-emitting device to detect the drive current, so as to generate a status signal based on the drive current. The light sensing unit is disposed adjacent to the light-emitting device to sense the light reflected from the lamp cover and generate a sensing signal based on the light reflected from the lamp cover. The comparison unit is used for comparing the sensing signal to and the status signal to generate a determining signal. The memory unit is used for receiving the determining signal and outputting a locking signal to the driving unit according to the determining signal, such that the driving unit can drive the light-emitting device selectively according to the locking signal.

When the lamp cover is damaged or the light-emitting device is not covered by the lamp cover and the voltage level of the sensing signal is lower than that of the status signal, the driving unit stops driving the light-emitting device; and when the lamp cover is not damaged or the light-emitting device is normally covered by the lamp cover and the voltage level of the sensing signal is not lower than that of the status signal, the driving unit keeps driving the light-emitting device.

Another aspect of the invention relates to a lamp, including a lamp holder, a light-emitting device, a lamp cover and a lamp driver. The light-emitting device is disposed on the aforesaid lamp holder. The lamp cover covers the aforesaid lamp holder to form a cavity, such that the light emitted by the light-emitting device partly passes through the lamp cover and is partly reflected from the lamp cover. The lamp driver determines whether the aforesaid lamp cover is damaged or the lamp cover still covers the light-emitting device based on the light reflected from the lamp cover to subsequently drive or turn off the light-emitting device selectively.

The aforesaid lamp driver includes a driving unit, a power detecting unit, a light sensing unit, a comparison unit and a memory unit. The driving unit is electrically connected to an external power supply to output a drive current to the light-emitting device. The power detecting unit is connected between the driving unit and the light-emitting device to detect the drive current, so as to generate a status signal based on the drive current. The light sensing unit is disposed adjacent to the light-emitting device to sense the light reflected from the lamp cover and generate a sensing signal based on the light reflected from the lamp cover. The comparison unit is used for comparing the sensing signal and the status signal to generate a determining signal. The memory unit is used for receiving the determining signal and outputting a locking signal to the driving unit according to the determining signal, such that the driving unit can drive the light-emitting device selectively according to the locking signal.

When the lamp cover is damaged or the light-emitting device is not to covered by the lamp cover and the voltage level of the sensing signal is lower than that of the status signal, the driving unit stops driving the light-emitting device; and when the lamp cover is not damaged or the light-emitting device is normally covered by the lamp cover and the voltage level of the sensing signal is not lower than that of the status signal, the driving unit keeps driving the light-emitting device.

In an embodiment, the aforesaid light-emitting device includes at least one light emitting diode.

Through application of the technical features of the invention, the driving unit permanently stops driving the light-emitting device when the lamp cover is damaged or the light-emitting device is not covered by the lamp cover, such that the light-emitting device is no longer supplied with power to thereby avoid the danger of electric shock to users caused by power that is supplied through exposed electric wires.

Although the invention has been disclosed with reference to the above embodiments, these embodiments are not intended to limit the invention. It will be apparent to those of skill in the art that various modifications and variations can be made without departing from the spirit and scope of the invention. Therefore, the scope of the invention shall be defined by the appended claims.

### BRIEF DESCRIPTION OF THE DRAWINGS

FIG. 1A is a schematic view of a lamp according to an embodiment of the invention;

FIG. 1B is a fragmentary view of the lamp shown in FIG. 1A, according to an embodiment of the invention, in which the lamp is shown in a state where the lamp cover is not damaged or normally covers a light-emitting device of the lamp;

FIG. 2 is a schematic circuit diagram of a lamp according to an embodiment of the invention; and

FIG. 3 is a schematic layout view of a lamp according to an embodiment of the invention, in which the lamp is shown in a state where the lamp cover is damaged or does not cover the light-emitting device of the lamp.

### DETAILED DESCRIPTION

The invention will be described in detail in the following embodiments with reference to the accompanying drawings. However, the embodiments described are not intended to limit the invention. Moreover, it is not intended for the description of operation to limit the order of implementation. Any device with equivalent functions that is produced from a structure formed by a recombination of elements shall fall within the scope of the invention. Moreover, the appending drawings are only used for illustration and are not drawn to scale.

Additionally, the terms “coupling” or “connecting” used herein both refer to a configuration in which two or more elements physically or electrically contact each other directly or indirectly, or in which two or more elements inter-operate or interact with each other.

The terms stated in this specification are only used for describing specific embodiments, and are not intended to limit the invention. The singular form such as “a/an,” “this” and “the” used in this specification also includes the plural form. Furthermore, it should be understood that when the terms “including,” “consisting” or “having” are used in this specification, they are used to list the existence of the stated features, positions, integers, steps, operations, components and/or elements in detail, and do not exclude the existence or addition of one or more of other features, positions, integers, steps, operations, components, elements and/or a group thereof.

Unless the terms are additionally defined, all of the terms (including technical and scientific terms) used in this specification have the same meaning as generally understood by those of ordinary skill in the art. It should further be understood that for example terms defined in dictionaries that are widely used should be considered as having meanings consistent with those of the terms used in the invention and used in articles of related techniques. Unless the meanings of terms are dearly defined in this specification, the terms should not be interpreted too ideally or literally.

For example “about”, “approximately” or “approach to” used in this specification generally mean within twenty percent of a specific value or range, preferably within ten percent, and optimally within five percent. The numerical values stated herein are approximate values, which means that even if it is not expressed definitely, the meanings of the terms “about,” “approximately” or to “approach to” are implied.

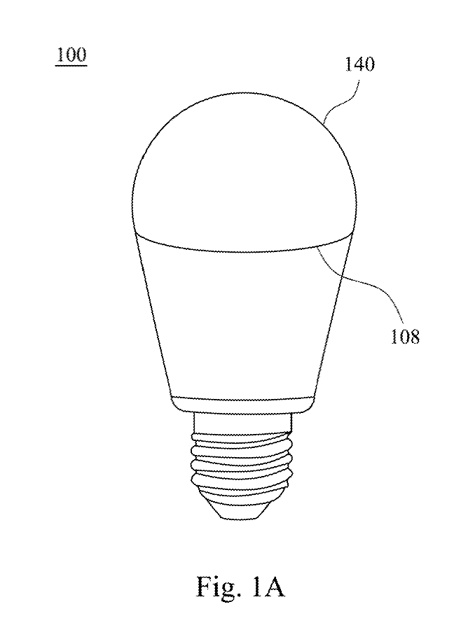

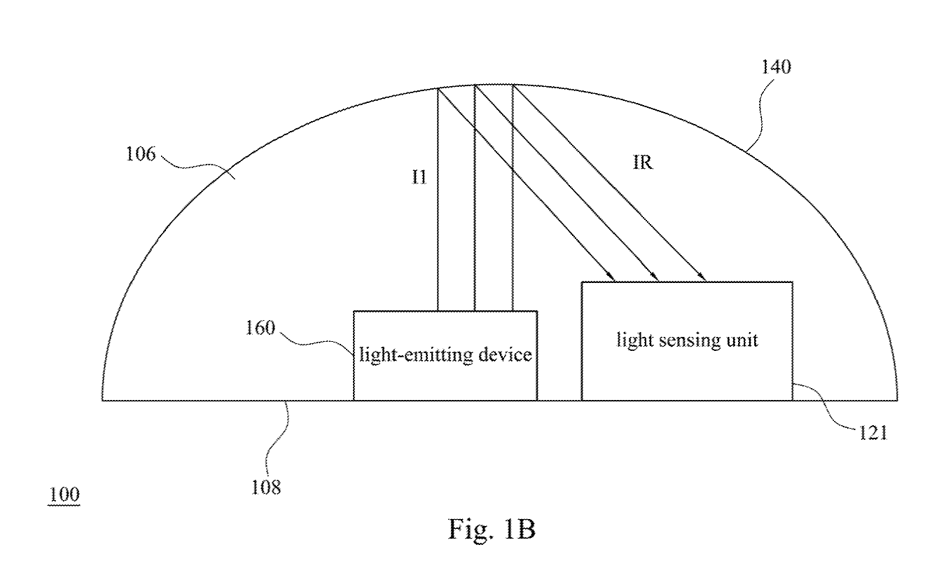

FIG. 1A is a schematic view of a lamp according to an embodiment of the invention. As illustrated in FIG. 1A, the lamp 100 includes a lamp cover 140 and a lamp holder 108, in which the lamp cover 140 is assembled with the lamp holder 108.

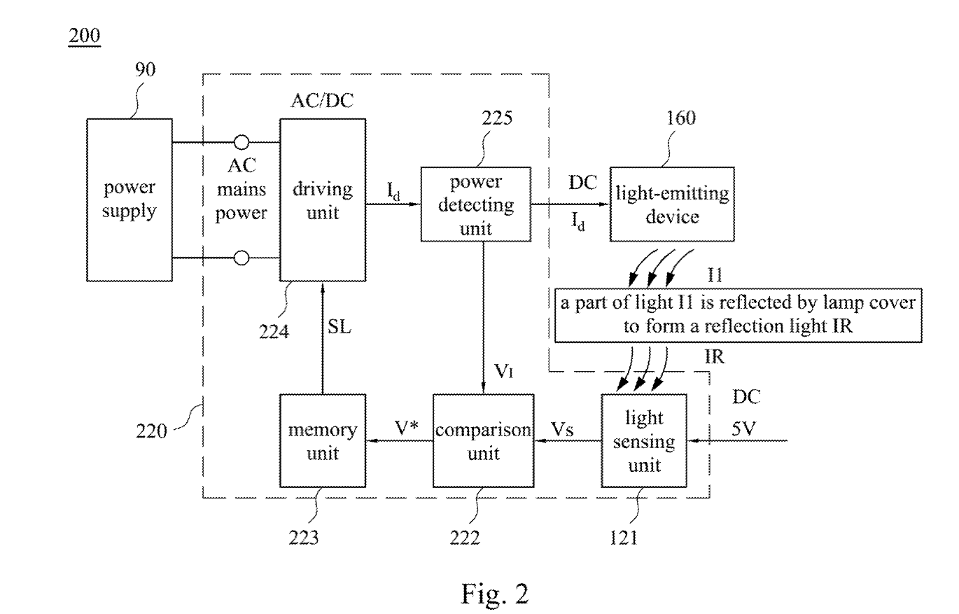

FIG. 1B is a fragmentary view of the lamp shown in FIG. 1A, according to an embodiment of the invention, in which the lamp is shown in a state where the lamp cover is not damaged or normally covers a light-emitting device of the lamp. The lamp 100 includes a light-emitting device 160, the lamp cover 140 and a lamp driver (e.g., a lamp driver 220 as shown in FIG. 2). The aforesaid lamp driver drives the light-emitting device 160 to emit light. The lamp cover 140 covers the light-emitting device 160, such that the light emitted by the light-emitting device 160 partly passes through the lamp cover 140 and is partly reflected by the lamp cover 140 to form a reflection light IR. The aforesaid lamp driver determines whether the lamp cover 140 is damaged or the lamp cover 140 still covers the light-emitting device 160 based on the reflection light IR reflected from the lamp cover 140 to subsequently drive or turn off the light-emitting device 160 selectively.

In an embodiment, the light-emitting device 160 includes at least one light emitting diode (LED).

In another embodiment, the light-emitting device 160 is disposed on the lamp holder 108, and the lamp cover 140 covers the lamp holder 108 to form a cavity 106, wherein the light-emitting device 160 is located in the cavity 106. Also in this embodiment, the light-emitting device 160 may include at least one LED.

It should be noted that the material of the lamp cover 140 may be plastic cement, glass or other transparent materials.

FIG. 2 is a schematic circuit diagram of a lamp according to an embodiment of the invention, wherein the circuit 200 of the lamp shown in FIG. 2 can be applied in, but not limited to, the embodiment shown in FIG. 1. In other words, without departing from the spirit and scope of the invention, those of ordinary skill in the art can apply the circuit 200 of the lamp in other similar lamps.

With reference also to FIG. 1 B, the light-emitting device 160 is electrically to connected to a lamp driver 220. The lamp driver 220 includes a driving unit 224, a power detecting unit 225, a light sensing unit 121, a comparison unit 222 and a memory unit 223.

The driving unit 224 is electrically connected to an external power supply 90, and outputs a drive current I_{d} to the light-emitting device 160. The power detecting unit 225 is connected between and electrically connected to the driving unit 224 and the light-emitting device 160. The power detecting unit 225 senses the drive current I_{d} and generates a corresponding status signal V₁. The light sensing unit 121 is disposed adjacent to the light-emitting device 160, and senses the reflection light IR reflected from the lamp cover 140 and generates a sensing signal Vs based on the reflection light IR reflected from the lamp cover 140. The comparison unit 222 receives and compares the sensing signal Vs and the status signal V₁ to subsequently generate a determining signal V*. The memory unit 223 receives the determining signal V* and outputs a locking signal SL to the driving unit 224 according to the determining signal V*, such that the driving unit 224 can drive the light-emitting device 160 selectively according to the locking signal SL.

In this embodiment, when the lamp cover 140 is damaged or the light-emitting device 160 is not covered by the lamp cover 140, the voltage level of the sensing signal Vs is lower than that of the status signal V₁, the driving unit 224 stops driving the light-emitting device 160. On the other hand, when the lamp cover 140 is not damaged or the light-emitting device 160 is normally covered by the lamp cover 140, the voltage level of the sensing signal Vs is not lower than that of the status signal V₁, the driving unit 224 keeps driving the light-emitting device 160.

In this embodiment, the light sensing unit 121 may be a photoelectric sensor, the power detecting unit 225 may be a current sensor, the comparison unit 222 may be a comparator, and the memory unit 223 may be a microcontroller unit (MCU) or a memory.

The following will describe the operation of the lamp 100 when the lamp cover 140 is not damaged or the light-emitting device 160 is normally covered by the lamp cover 140, using by way of example the lamp 100 shown in FIG. 1B and the lamp driver 220 shown in FIG. 2.

First the external power supply 90 provides AC mains power to the to driving unit 224. The driving unit 224 then converts the aforesaid AC mains power into the DC drive current I_{d}, and subsequently outputs the drive current I_{d} to the light-emitting device 160 to drive the light-emitting device 160 to emit light. The light I1 emitted by the light-emitting device 160 partly passes through the lamp cover 140 and is partly reflected by the lamp cover 140 to form a reflection light IR. The light sensing unit 121 senses the reflection light IR reflected from the lamp cover 140 and generates the sensing signal Vs according to the reflection light IR reflected from the lamp cover 140. The light sensing unit 121 subsequently outputs the sensing signal Vs with a voltage level. When the lamp cover 140 is not damaged or the light-emitting device 160 is normally covered by the lamp cover 140 (as shown in. FIG. 1), the voltage level, of the sensing signal Vs is greater than 0.9 times the maximum value of the voltage level outputted by the light sensing unit 121.

The power detecting unit 225 senses the drive current. I_{d} to generate the status signal V₁. The comparison unit 222 compares the sensing signal Vs and the status signal V₁ to subsequently generate the determining signal V*. When the lamp cover 140 is not damaged or the light-emitting device 160 is normally covered by the lamp cover 140 (as shown in FIG. 1), the voltage level of the sensing signal Vs is not lower than that of the status signal V₁, the comparison unit 222 outputs a determining signal V* with a high voltage level, indicating that the lamp cover 140 is not damaged or the light-emitting device 160 is normally covered by the lamp cover 140. The memory unit 223 receives the determining signal V* with the high voltage level, and outputs a locking signal SL to the driving unit 224 according to the determining signal V* with the high voltage level, such that the driving unit 224 keeps driving the light-emitting device 160. The above is the operation of the lamp 100 when the lamp cover 140 is not damaged or the light-emitting device 160 is normally covered by the lamp cover 140.

In this embodiment, in regard to the voltage level outputted by the light sensing unit 121, for example, when the maximum value of the DC voltage level is 5 volts (V) such that the lamp cover 140 is not damaged or the light-emitting device 160 is normally covered by the lamp cover 140 (as shown in FIG. 1), the sensing signal Vs may have a DC voltage level of 4.84 V. Therefore, the voltage level of the sensing signal Vs is 0.968 (the result of dividing 4.84 by 5) to times the maximum value of the voltage level outputted by the light sensing unit 121. In other words, the voltage level of the sensing signal Vs is greater than 0.9 times the maximum value of the voltage level outputted by the light sensing unit 121.

Furthermore, when the driving unit 224 stops outputting the drive current. I_{d} to the light-emitting device 160, the power detecting unit 225 does not detect the drive current I_{d}, such that the power detecting unit 225 cannot generate the status signal V₁. In this situation, the comparison unit 222 does not perform a determination operation so as to avoid an erroneous determination.

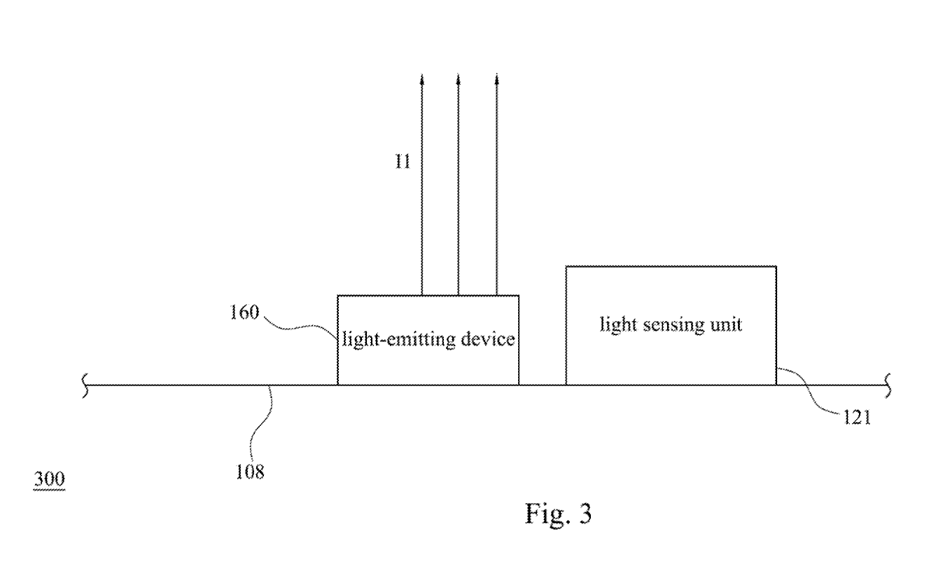

FIG. 3 is a schematic layout view of a lamp according to an embodiment of the invention, in which the lamp is shown in a state where the lamp cover is damaged or the light-emitting device of the lamp is not covered by the lamp cover. The following will describe the operation of the lamp 300 when the lamp cover 140 is damaged or the light-emitting device 160 is not covered by the lamp cover 140, using by way of example the lamp 300 shown in FIG. 3 and the circuit of the lamp driver 220 shown in FIG. 2.

First the external power supply 90 provides AC mains power to the driving unit 224. The driving unit 224 then converts the aforesaid AC mains power into the DC drive current I_{d}, and subsequently outputs the drive current I_{d} to the light-emitting device 160 to drive the light-emitting device 160 to emit light I1. The LED of the light-emitting device 160 is a directional light source, such that when the lamp cover 140 shown in FIG. 1 is damaged or the light-emitting device 160 is not covered by the lamp cover 140, the light sensing unit 121 cannot sense the light emitted by the light-emitting device 160 and the light reflected by the lamp cover 140, such that the light sensing unit 121 outputs a sensing signal Vs with a low voltage level. When the lamp cover 140 is damaged or the light-emitting device 160 is not covered by the lamp cover 140 (as shown in FIG. 3), the voltage level of the sensing signal Vs is lower than 0.9 times the maximum value of the voltage level outputted by the light sensing unit 121.

The power detecting unit 225 senses the drive current I_{d} to generate the status signal V₁. The comparison unit 222 compares the sensing signal Vs and the status signal V₁ to subsequently generate the determining signal V*. When the lamp cover 140 is damaged or the light-emitting device 160 is not covered to by the lamp cover 140 (as shown in FIG. 3), the voltage level of the sensing signal Vs is lower than that of the status signal V₁, and the comparison unit 222 outputs a determining signal V* with a low voltage level. The memory unit 223 receives the determining signal. V* with the low voltage level and outputs a locking signal SL with a voltage level to the driving unit 224 according to the determining signal V* with the low voltage level, such that the driving unit 224 stops outputting the drive current. I_{d} according to the locking signal SL with the voltage level, so as to permanently stop driving the light-emitting device 160. Therefore, the light-emitting device 160 is no longer driven by power, rendering the lamp 300 inoperable, and as a result, the danger of electric shock to users caused by power supply through exposed electric wires is avoided. The above is the operation of the lamp 300 when the lamp cover 140 shown in FIG. 1 is damaged or the light-emitting device 160 is not covered by the lamp cover 140.

It should be noted that after the driving unit 224 stops driving the light-emitting device 160, the lamp driver 220 still can perform other operations.

In this embodiment, in regard to the voltage level outputted by the light sensing unit 121, for example, when the maximum value of the DC voltage level is 5 volts (V) such that the lamp cover 140 is damaged or the light-emitting device 160 is not covered by the lamp cover 140 (as shown in FIG. 3), the sensing signal Vs may have a DC voltage level of DC 1.21 V. Therefore, the voltage level of the sensing signal Vs is 0.242 (the result of dividing 1.21 by 5) times the maximum value of the voltage level outputted by the light sensing unit 121. In other words, the voltage level of the sensing signal Vs is far below 0.9 times the maximum value of the voltage level outputted by the light sensing unit 121.

Additionally, when the lamp cover 140 is damaged or the light-emitting device 160 is not covered by the lamp cover 140, the light-emitting device 160 is not emitting light, the light sensing unit 121 senses the light from an ambient light source(s). When the light sensing unit 121 senses the light from an ambient light source and does not senses the light emitted by the light-emitting device 160, the voltage level of the sensing signal Vs outputted by the light sensing unit 121 may be, for example, 0.952 V, i.e., 0.194 (the result of dividing 0.952 by 5) times the maximum value of the voltage level outputted by the light sensing unit 121. In other words, when the lamp cover 140 is damaged or the to light-emitting device 160 is not covered by the lamp cover 140, the light-emitting device 160 is not emitting light, the voltage level of the sensing signal Vs is far below 0.9 times the maximum value of the voltage level outputted by the light sensing unit 121, which is similar to a state where the lamp cover 140 is damaged or the light-emitting device 160 is not covered by the lamp cover 140 and the light-emitting device 160 is driven to emit light.

The lamp described in the aforesaid embodiments can be applied to various lamp source devices, including lamp source devices that are designed in a lighting tube or light bulb configuration.

In view of the above, it can be seen that by applying the lamp of the technical field of the invention, the driving unit permanently stops driving the light-emitting device when the lamp cover is damaged or the light-emitting device is not covered by the lamp cover, i.e., the light-emitting device is not supplied with power. Hence, the danger of electric shock to users caused by power supply through exposed electric wires is avoided.

Although the invention has been disclosed with reference to the above embodiments, these embodiments are not intended to limit the invention. It will be apparent to those of skill in the art that various modifications and variations can be made without departing from the spirit and scope of the invention. Therefore, the scope of the invention shall be defined by the appended claims.

What is claimed is:

1. A lamp, comprising:
a light-emitting device;
a lamp cover which covers the light-emitting device such that the light emitted by the light-emitting device partly passes through the lamp cover and is partly reflected from the lamp cover; and
a lamp driver which determines whether the lamp cover is damaged or the lamp cover still covers the light-emitting device based on the light reflected to from the lamp cover to subsequently drive or turn off the light-emitting device selectively, wherein the lamp driver comprises:
a driving unit which is electrically connected to an external power supply to output a drive current to the light-emitting device;
a power detecting unit which is connected between the driving unit and the light-emitting device to detect the drive current, so as to generate a status signal based on the drive current;
a light sensing unit which is disposed adjacent to the light-emitting device to sense the light reflected from the lamp cover and generate a sensing signal based on the light reflected from the lamp cover;
a comparison unit which is used for comparing the sensing signal and the status signal to generate a determining signal; and
a memory unit which is used for receiving the determining signal and outputting a locking signal to the driving unit according to the determining signal, such that the driving unit drives the light-emitting device selectively according to the locking signal;
wherein when the lamp cover is damaged or the light-emitting device is not covered by the lamp cover, the voltage level of the sensing signal is lower than that of the status signal, the driving unit stops driving the light-emitting device; and when the lamp cover is not damaged or the light-emitting device is normally covered by the lamp cover, the voltage level of the sensing signal is not lower than that of the status signal, the driving unit keeps driving the light-emitting device.

2. The lamp of claim wherein the light-emitting device comprise t least one light emitting diode.

3. A lamp, comprising:
a lamp holder;
a light-emitting device which is disposed on the lamp holder;
a lamp cover which covers the lamp holder to form a cavity, such that the light emitted by the light-emitting device partly passes through the lamp cover and is partly reflected from the lamp cover; and
a lamp driver which determines whether the lamp cover is damaged or the lamp cover still covers the light-emitting device based on the light reflected from the lamp cover to subsequently drive or turn off the light-emitting device selectively, wherein the lamp driver comprises:
a driving unit which is electrically connected to an external power supply to output a drive current to the light-emitting device;
a power detecting unit which is connected between the driving unit and the light-emitting device to detect the drive current, so as to generate a status signal based on the drive current;
a light sensing unit which is disposed on the lamp holder and adjacent to the light-emitting device to sense the light reflected from the lamp cover and generate a sensing signal based on the light reflected from the lamp cover;
a comparison unit which is used for comparing the sensing signal and the status signal to generate a determining signal; and
a memory unit which is used for receiving the determining signal and outputting a locking signal to the driving unit according to the determining signal, such that the driving unit drives the light-emitting device selectively according to the locking signal;
wherein when the lamp cover is damaged or the light-emitting device is not covered by the lamp cover, the voltage level of the sensing signal is lower than that of the status signal, the driving unit stops driving the light-emitting device; and when the lamp cover is not damaged or the light-emitting device is normally covered by the lamp cover, the voltage level of the sensing signal is not lower than that of the status signal, the driving unit keeps driving the light-emitting device.

4. The lamp of claim 3, wherein the light-emitting device comprises at least one light emitting diode.
